(19) United States
(12) Patent Application Publication
(10) Pub. No.: US 2006/0259918 A1
(43) Pub. Date: Nov. 16, 2006

(54) Method and apparatus for mounting a storage device in an information handling system

(75) Inventors: James R. Utz, Round Rock, TX (US); David W. Grunow, Round Rock, TX (US); Ryan L. Salzer, Pflugerville, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/129,918

(22) Filed: May 16, 2005

(51) Int. Cl. G11B 33/08; G11B 33/14

(52) U.S. Cl. 720/651

(57) ABSTRACT

A storage device mounting apparatus includes a modular device casing defining a storage device housing, a shock isolation material coupled to the modular device casing and located in the storage device housing, and a storage device positioned in the storage device housing and engaging the shock isolation material. The apparatus may be interchanged with a standard storage device to provide information handling systems in a build to order fashion depending the strength of the shock and vibration events the information handling system is expected to experience.

### BACKGROUND

The present disclosure relates generally to information handling systems, and more particularly to a method and apparatus for mounting a storage device in an information handling system.

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically include storage devices for storing data for use by the information handling system. Storage devices are generally sensitive to shock and vibration, so with regards to information handling systems which are expected to experience stronger than normal shock and vibration events, the mounting of these storage device to the information handling system chassis can raise a number of issues.

Typical information handling systems include the storage device rigidly mounted to the information handling system chassis. The rigid mounting of the storage device to the information handling system chassis is ideal for space considerations, but can prevent the proper shock and vibration isolation of the storage device which can lead to the loss of data on the storage device in the event of strong shock and vibration events.

The conventional solution to this problem is to provide larger, heavier, and more expensive information handling systems which include non-modular storage devices that provide added shock and vibration protection for the storage device when the information handling system is expected to experience the type of shock and vibration events which require such protection. However, such solutions are undesirable because of the increased size, weight, and cost of the information handling system, and because the use of a non-modular storage device limits the ability to provide the information handling system and storage device in a build to order fashion.

Accordingly, it would be desirable to provide a method and apparatus for mounting a storage device to an information handling system absent the disadvantages found in the prior methods discussed above.

### SUMMARY

According to one embodiment, a storage device mounting apparatus is provided which includes a modular device casing defining a storage device housing, a shock isolation material coupled to the modular device casing and located in the storage device housing, and storage device positioned in the storage device housing and engaging the shock isolation material.

A principal advantage of this embodiment is that an storage device may be provided in the storage device mounting apparatus which is interchangeable with a standard storage device but which offers additional shock and vibration protection, allowing an information handling system to be built to order based on the shock and vibration events the information handling system is expected to experience.

### BRIEF DESCRIPTION OF THE DRAWINGS

FIG. 1 is a schematic view illustrating an embodiment of an information handling system.

FIG. 2a is a top perspective view illustrating an embodiment of a modular device bottom portion.

FIG. 2b is a bottom perspective view illustrating an embodiment of the modular device bottom portion of FIG. 2a.

FIG. 3a is a is a top perspective view illustrating an embodiment of a modular device top portion used with the modular device bottom portion of FIG. 2a.

FIG. 3b is a is a bottom perspective view illustrating an embodiment of the modular device top portion of FIG. 3a.

FIG. 4 is a perspective view illustrating an embodiment of a circuit board used with the modular device bottom portion of FIG. 2a and the modular device top portion of FIG. 3a.

FIG. 5 is a perspective view illustrating an embodiment of a storage device used with the modular device bottom portion of FIG. 2a, the modular device top portion of FIG. 3a, and the circuit board of FIG. 4.

FIG. 6 is a perspective view illustrating an embodiment of an information handling system.

FIG. 7a is a flow chart illustrating a method for mounting a storage device in an information handling system.

FIG. 7b is a perspective view illustrating a plurality of shock isolation material members being coupled to the modular device bottom portion of FIG. 2a during the method of FIG. 7a.

FIG. 7c is a perspective view illustrating a plurality of shock isolation material members coupled to the modular device bottom portion of FIG. 2a during the method of FIG. 7a.

FIG. 7d is a perspective view illustrating a plurality of shock isolation material members being coupled to the modular device top portion of FIG. 3a during the method of FIG. 7a.

FIG. 7e is a perspective view illustrating a plurality of shock isolation material members coupled to the modular device top portion of FIG. 3a during the method of FIG. 7a.

FIG. 7f is a perspective view illustrating the circuit board of FIG. 4 coupled to the modular device bottom portion of FIG. 7c during the method of FIG. 7a.

FIG. 7g is a perspective view illustrating the storage device of FIG. 5 coupled to the circuit board and modular device bottom portion of FIG. 7f during the method of FIG. 7a.

FIG. 7h is a perspective view illustrating the modular device top portion of FIG. 3a being coupled to the modular device bottom portion of FIG. 7g during the method of FIG. 7a.

FIG. 7i is a perspective view illustrating the modular device top portion of FIG. 3a coupled to the modular device bottom portion of FIG. 7g during the method of FIG. 7a.

FIG. 7j is a perspective view illustrating the apparatus of FIG. 7i being coupled to the information handling system of FIG. 6 during the method of FIG. 7a.

FIG. 7k is a perspective view illustrating the apparatus of FIG. 7i coupled to the information handling system of FIG. 6 during the method of FIG. 7a.

FIG. 8 is a perspective view illustrating an alternative embodiment of a storage device mounting apparatus.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

In one embodiment, information handling system 10, FIG. 1, includes a microprocessor 12, which is connected to a bus 14. Bus 14 serves as a connection between microprocessor 12 and other components of computer system 10. An input device 16 is coupled to microprocessor 12 to provide input to microprocessor 12. Examples of input devices include keyboards, touchscreens, and pointing devices such as mouses, trackballs and trackpads. Programs and data are stored on a mass storage device 18, which is coupled to microprocessor 12. Mass storage devices include such devices as hard disks, optical disks, magneto-optical drives, floppy drives and the like. Computer system 10 further includes a display 20, which is coupled to microprocessor 12 by a video controller 22. A system memory 24 is coupled to microprocessor 12 to provide the microprocessor with fast storage to facilitate execution of computer programs by microprocessor 12. In an embodiment, a chassis 26 may house some or all of the components of information handling system 10. It should be understood that other busses and intermediate circuits can be deployed between the components described above and microprocessor 12 to facilitate interconnection between the components and the microprocessor.

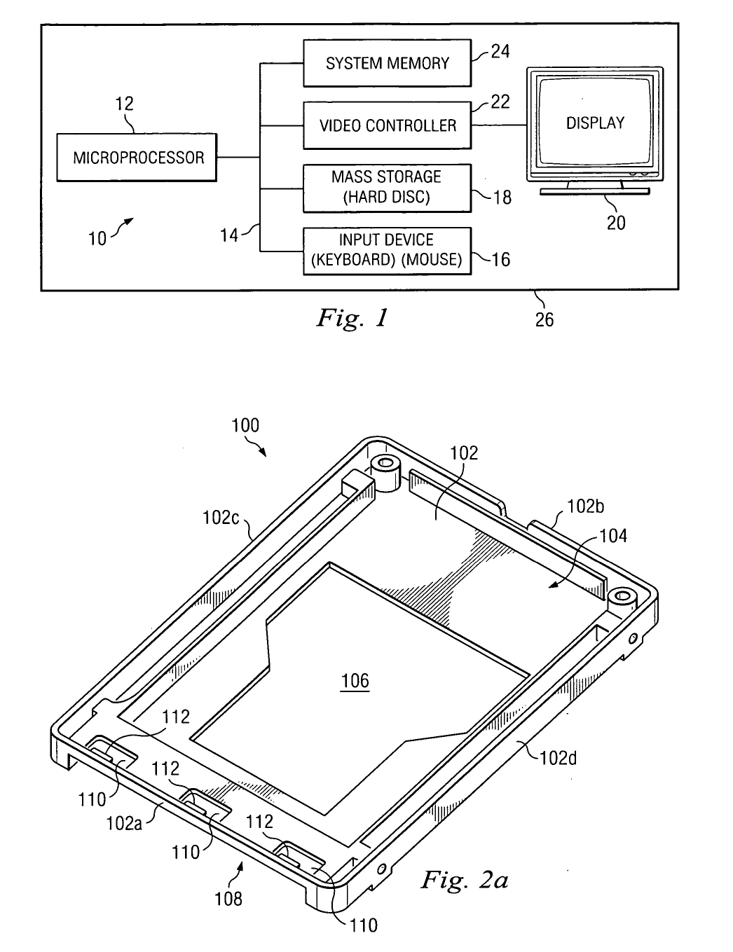

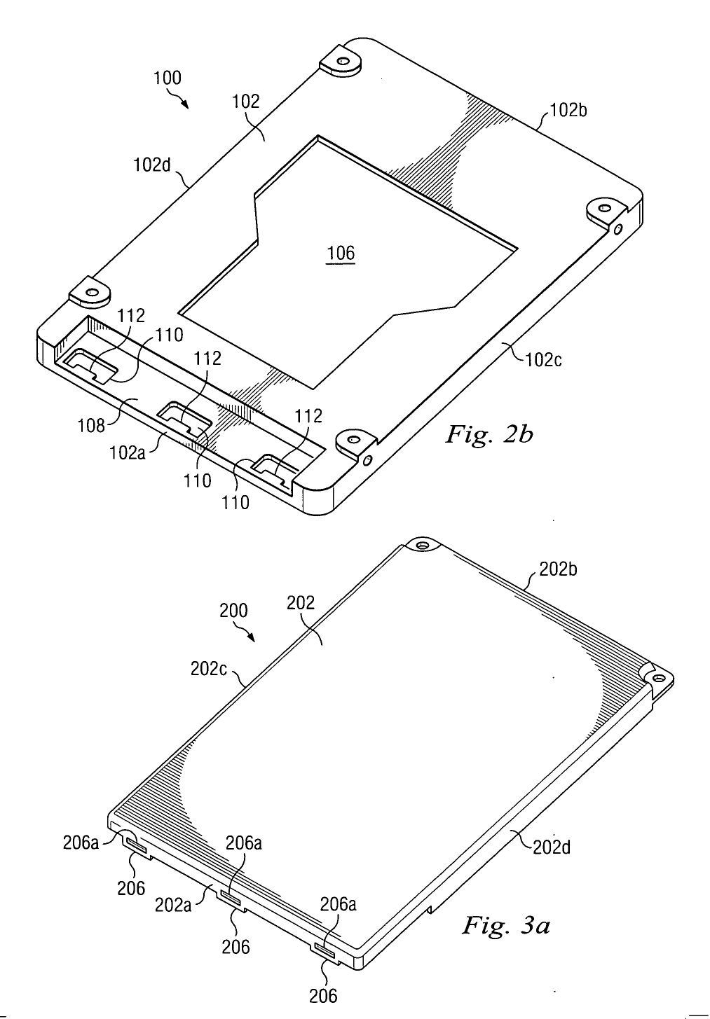

Referring now to FIGS. 2a and 2b, a modular device bottom portion 100 is illustrated. Modular device bottom portion 100 includes a base 102 having a front end 102a, a rear end 102b located opposite the front end 102a, a plurality of sides 102c and 102d extending between the front end 102a and the rear end 102b, and defining a bottom portion housing 104 between the front end 102a, the rear end 102b, and the sides 102c and 102d. A board passageway 106 is defined by the base 102, extends through the base 102, and is centrally located on the base 102 and adjacent the bottom portion housing 104. A plug channel 108 is also defined by the base 102 and is located adjacent the front end 102a of the base 102. A plurality of apertures 110 are defined by the base 102, extend through the base 102, and are positioned in a spaced apart relationship and located adjacent the front end 102a of the base 102 and adjacent the plug channel 108. A plurality of top portion coupling members 112 extend from the front end 102a of the base 102 and are positioned in a spaced apart relationship and located adjacent each of the apertures 110.

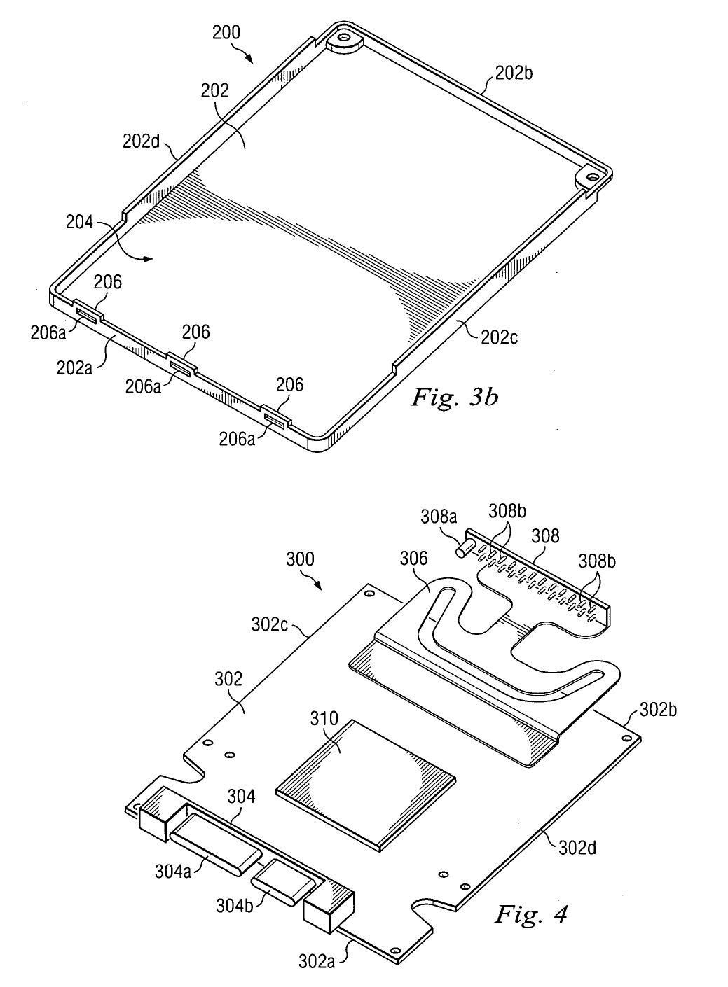

Referring now to FIGS. 3a and 3b, a modular device top portion 200 is illustrated. Modular device top portion 200 includes a base 202 having a front end 202a, a rear end 202b located opposite the front end 202a, a plurality of sides 202c and 202d extending between the front end 202a and the rear end 202b, and defining a top portion housing 204 between the front end 202a, the rear end 202b, and the sides 202c and 202d. A plurality of bottom portion coupling members 206 extend from the front end 202a of the base 202, with each bottom portion coupling member 206 defining an aperture 206a which is centrally located on the bottom portion coupling member 206.

Referring now to FIG. 4, a circuit board 300 is illustrated. Circuit board includes a board base 302 having a front end 302a, a rear end 302b located opposite the front end 302a, and a plurality of sides 302c and 302d extending between the front end 302a and the rear end 302b. A device plug 304 is mounted to the board base 302, positioned adjacent the front end 302a of the board base 302, and includes a plurality of plug members 304a and 304b extending from the device plug 304 and along its length. A flex cable 306 is mounted to the board base 302, positioned adjacent the rear end 302b of the board base 302, and includes a storage device connector 308 in its end which includes a guide peg 308a and a plurality of pins 308b extending from the storage device connector 308. A converter 310 is mounted to the board base 302 and is centrally located on the board base 302 between the flex cable 306 and the device plug 304. The storage device connector 308, converter 310, and the device plug 304 are electrically coupled to each other through the flex cable 306 and the board base 302. In an embodiment, the converter 310 includes components for converting 5V to 3.3V and the device plug 304 is a 2.5 inch storage device parallel ATA (PATA) connector. In an embodiment, the converter 310 includes components for PATA to serial ATA (SATA) conversion and for converting 5V to 3.3V and the device plug 304 is a 2.5 inch storage device SATA connector.

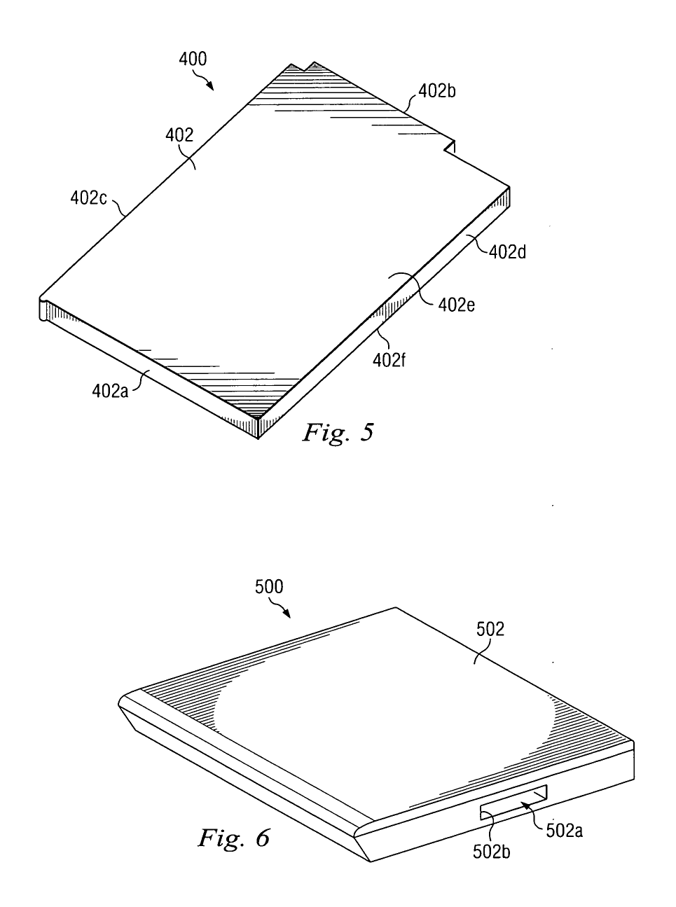

Referring now to FIG. 5, a storage device 400 is illustrated. Storage device 400 includes a base 402 having a front surface 402a, a rear surface 402b located opposite the front surface 402a, a plurality of side surfaces 402c and 402d extending between the front surface 402a and the rear surface 402b, a top surface 402e, and a bottom surface 402f located opposite the top surface 402e. An electrical coupler (not shown) is positioned on the rear surface 402b of the base 402 and is operable to electrically couple the storage device 400 to a connector. In an embodiment, the storage device 400 is one of the components of the information handling system 10, described above with reference to FIG. 1. In an embodiment, the storage device 400 is, for example, a hard disk drive. In an embodiment, the storage device 400 is an 1.8 inch storage device.

Referring now to FIG. 6, an information handling system 500 is illustrated. Information handling system 500 includes a chassis 502 which defines a storage device slot 502a having a slot entrance 502b. In an embodiment, the storage device slot 502a has dimensions such that it may house a standard storage device which may be, for example, a storage device which does not include additional shock and vibration protection for that device such as, for example, a conventional 2.5 inch storage device. In an embodiment, the information handling system 500 may be the information handling system 10, described above with reference to FIG. 1, and the chassis 502 may be the chassis 26, described above with reference to FIG. 1.

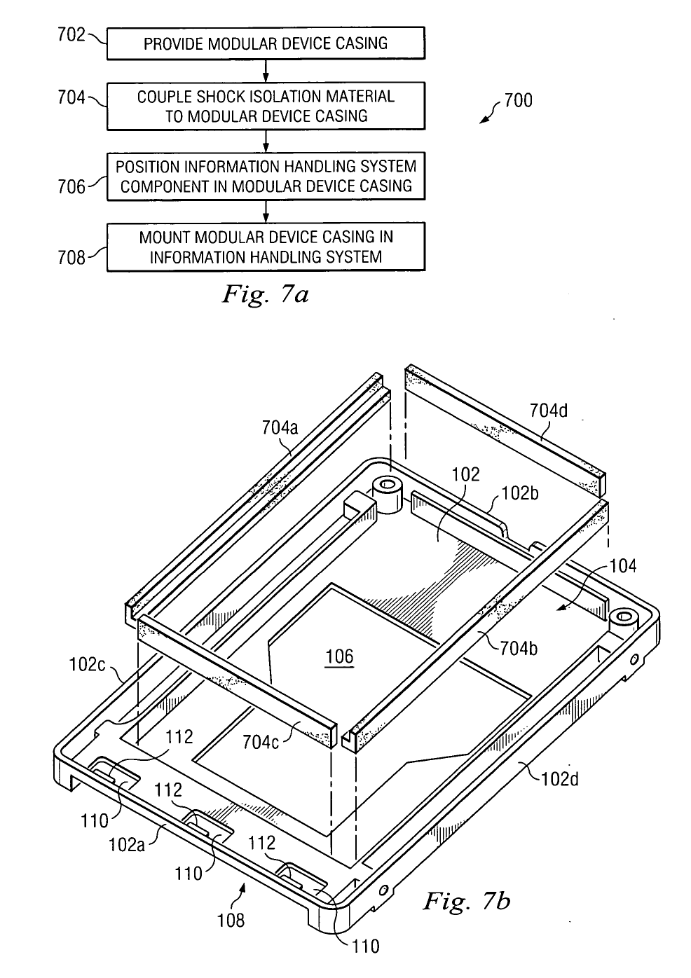

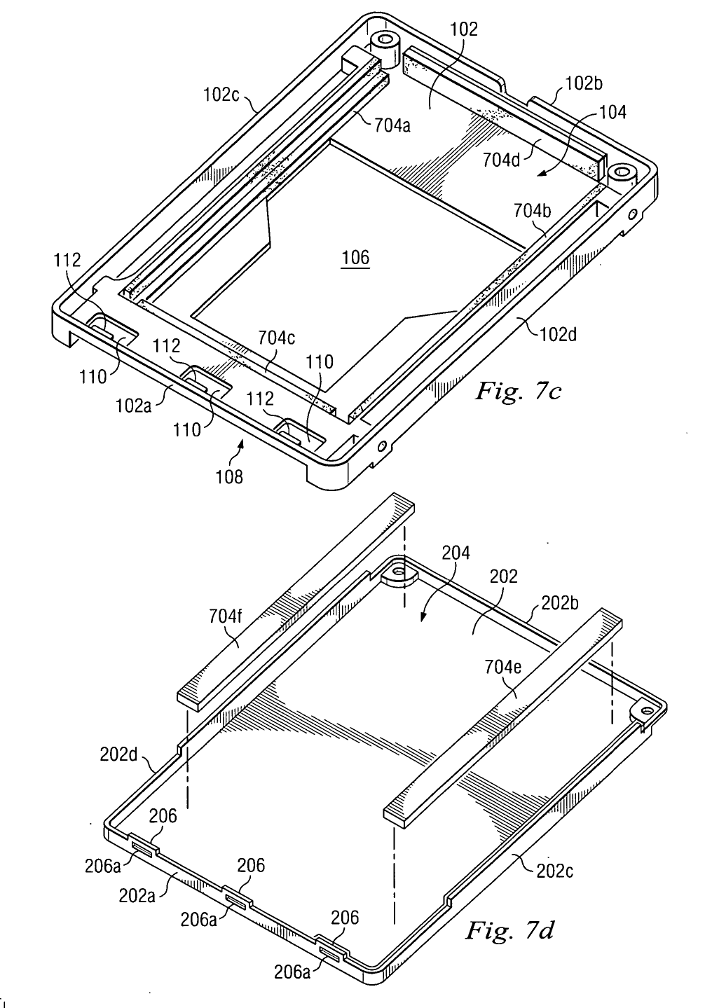

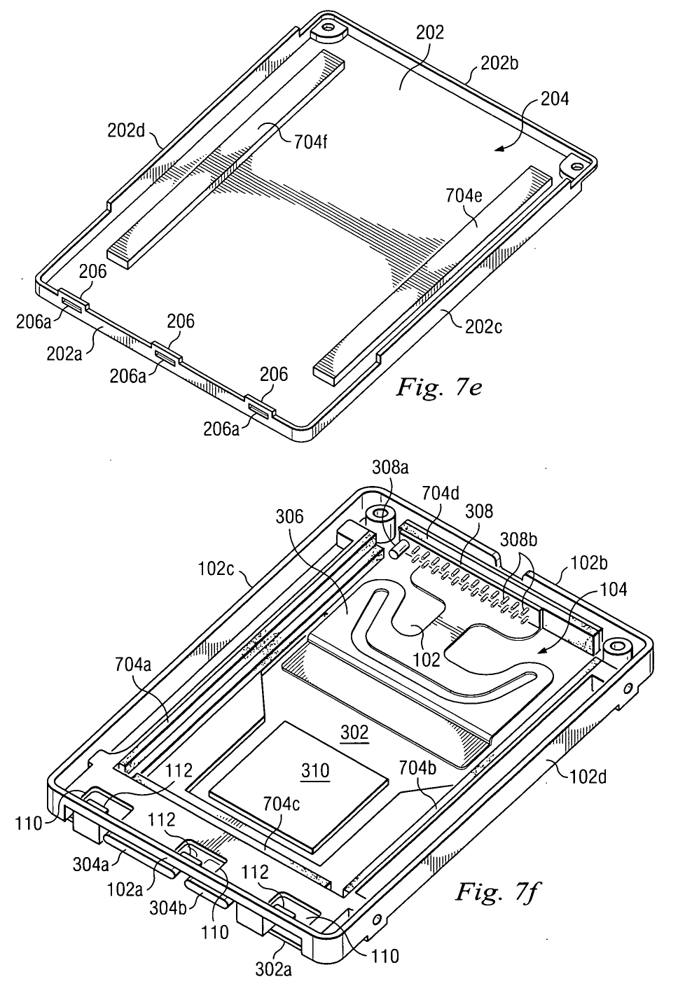

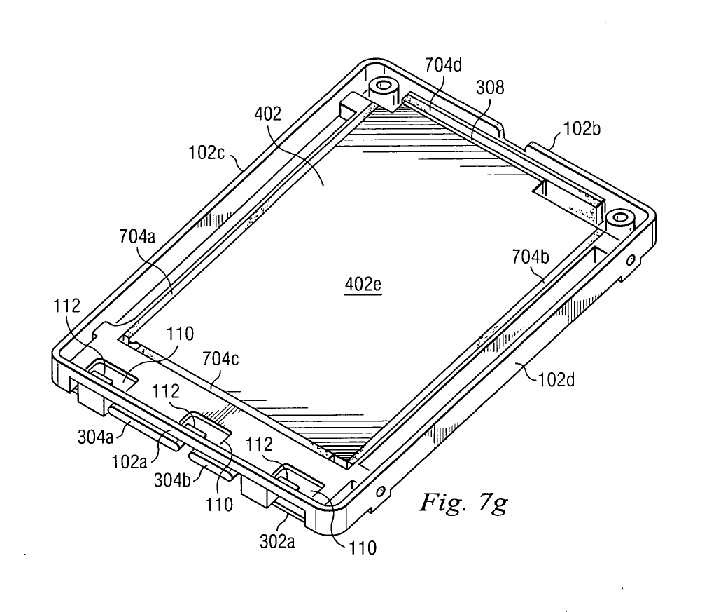

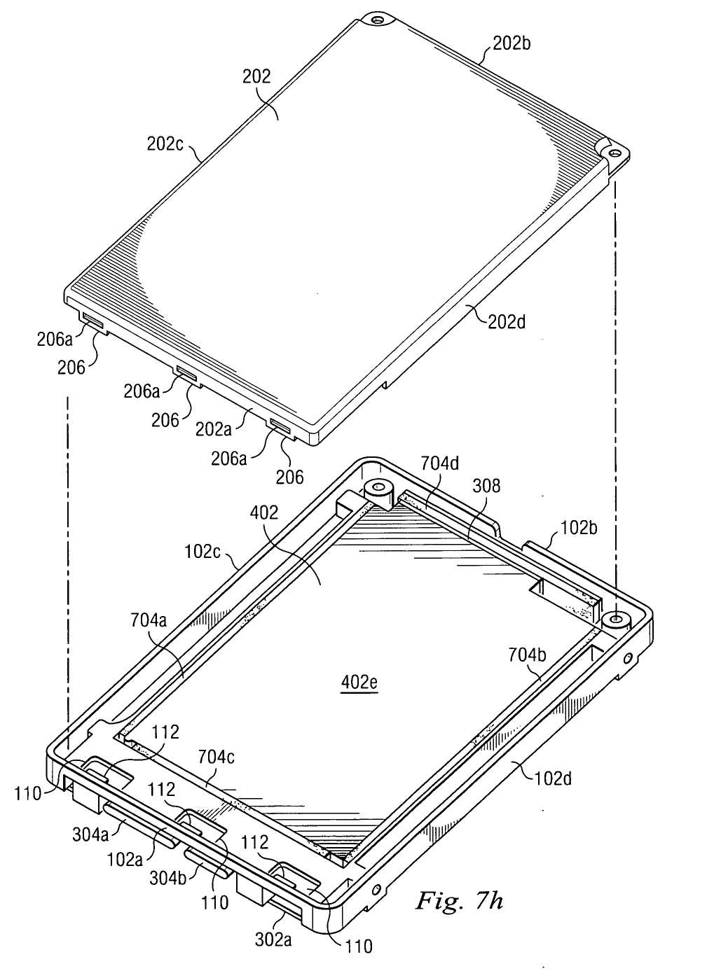

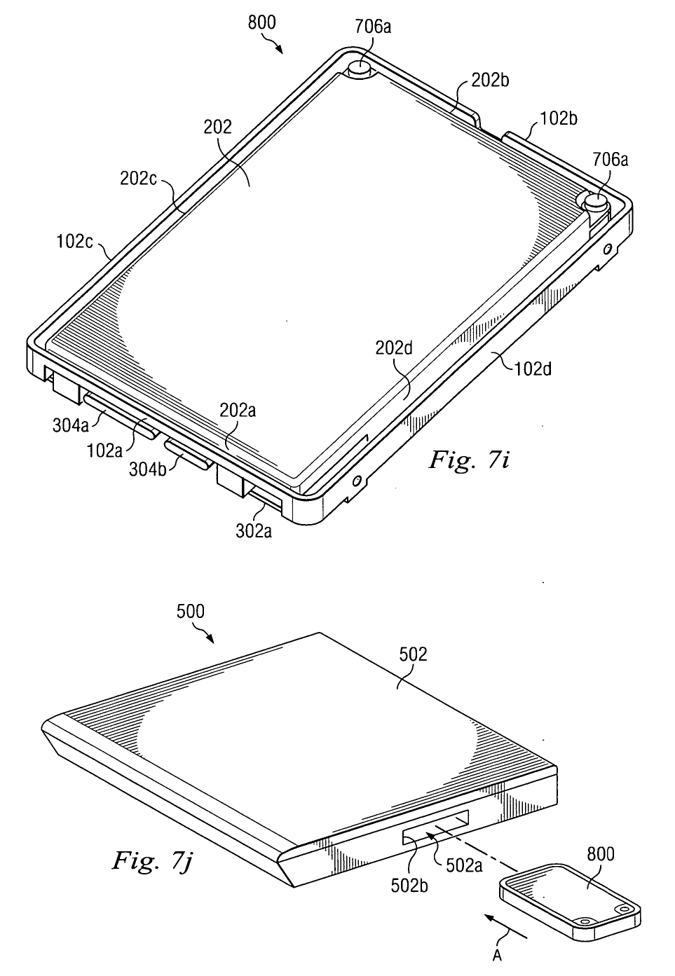

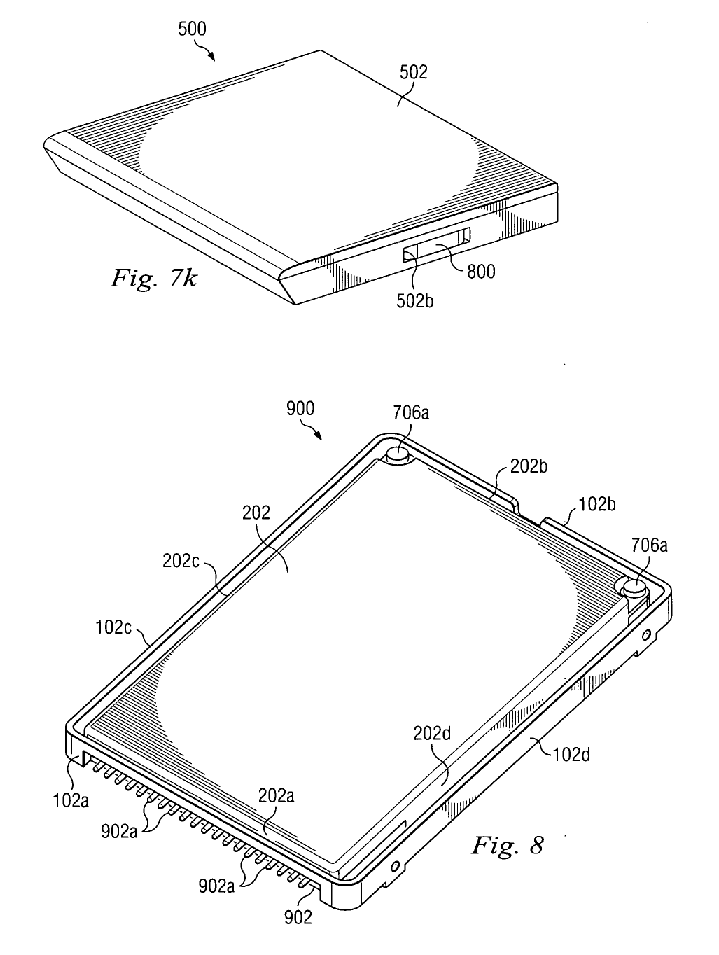

Referring now to FIGS. 7a, 7b, 7c, 7d, and 7e, a method 700 for mounting a storage device in an information handling system is illustrated. The method 700 begins at step 702 where a modular device casing, which is made up of modular device bottom portion 100 and modular device top portion 200, is provided. The method 700 then proceeds to step 704, where shock isolation material is coupled to the modular device casing. A plurality of shock isolation material members 704a and 704b are coupled to the base 102 of modular device bottom portion 100 and in bottom portion housing 104 adjacent sides 102c and 102d, respectively, as illustrated in FIGS. 7b and 7c. A plurality of shock isolation material members 704c and 704d are coupled to the base 102 of modular device bottom portion 100 and in bottom portion housing 104 adjacent front end 102a and rear end 102b, respectively, as illustrated in FIGS. 7b and 7c. A plurality of shock isolation material members 704e and 704f are coupled to the base 202 of modular device top portion 200 and in top portion housing 204 adjacent sides 202c and 202d, respectively, as illustrated in FIGS. 7d and 7e. In an embodiment, the shock isolation material members 704a, 704b, 704c, 704d, 704e, and 704f include a foam material or other equivalent shock isolation material known in the art.

Referring now to FIGS. 4, 5, 7a, 7c, 7e, 7f, 7g, and 7h, the method 700 proceeds to step 706 where the storage device 400 is positioned in the modular device casing. The circuit board 300 is coupled to the modular device bottom portion 100 such that the circuit board 300 is positioned partially in the board passageway 106 on modular device bottom portion 100. With the circuit board 300 coupled to the modular device bottom portion 100 in this manner, the device plug 304 is positioned in the plug channel 108 and located adjacent the front end 102a of the modular device bottom portion 100, and the flex cable 306 extends into the bottom portion housing 104 such that the storage device connector 308 is located in the bottom portion housing 104 adjacent the rear end 102b of the modular device bottom portion 100 and engaging the shock isolation material member 704d, as illustrated in FIG. 7f. The storage device 400 is then positioned in the bottom portion housing 104 such that the rear surface 402b engages the guide peg 308a and the pins 308b on the storage device connector 308, the side surfaces 402c and 402d and bottom surface 402f engage the shock isolation material members 704a and 704b, respectively, and the front surface 402a engages the shock isolation material member 704c, as illustrated in FIG. 7g. Modular device top portion 200 is then coupled to the modular device bottom portion 100 by positioning bottom portion coupling members 206 in the apertures 110 such that the top portion coupling members 112 are positioned in the apertures 206a on bottom portion coupling members 206, as illustrated in FIGS. 7h and 7i. A plurality of fasteners 706a may then be used to secure the modular device top portion 200 to the modular device bottom portion 100, as illustrated in FIG. 7i. With the modular device top portion 200 coupled to the modular device bottom portion 100, the shock isolation members 704f and 704e coupled to modular device top portion 200 engage the top surface 402e of the storage device 400, and the storage device 400 is located in a storage device housing which includes bottom portion housing 104 on modular device bottom portion 100 and top portion housing 204 on modular device top portion 200. With the modular device top portion 200 coupled to the modular device bottom portion 100, a storage device mounting apparatus 800 is provided which is approximately the same dimensions as a standard storage device, and the storage device 400 in the storage device mounting apparatus 800 is smaller than a standard storage device. In an embodiment, a standard storage device is an storage device which does not provide additional shock and vibration protection for that device. In an embodiment, a standard storage device includes a 2.5 inch storage device, and the storage device 400 in storage device mounting apparatus 800 includes a 1.8 inch storage device. In an embodiment, a standard storage device includes a 3.5 inch storage device and the storage device 400 in storage device mounting apparatus 800 includes a 2.5 inch storage device.

Referring now to FIGS. 7a, 7g, 7i, 7j, and 7k, the method 700 proceeds to step 708 where the storage device mounting apparatus 800 is mounted in the information handling system 500. The storage device mounting apparatus 800 is positioned in front of the slot entrance 502b of storage device slot 502a on information handling system chassis 500 and then moved in a direction A. Because the storage device mounting apparatus 800 is approximately the same dimensions as a standard storage device, which the storage device slot 502a is designed to house, the storage device mounting apparatus 800 enters the storage device slot 502a and may be mounted to the information handling system 500, as illustrated in FIG. 7k. An electrical coupler (not shown) in the storage device slot 502a engages the plug members 304a and 304b to electrically couple the storage device 400 to the information handling system 500. The storage device mounting apparatus 800 may be interchanged with a standard storage device depending on the strength of the shock and vibration events the information handling system 500 is expected to experience. Thus, an apparatus is provided which allows an information handling system to be built to order depending on the strength of the shock and vibration events the information handling system is expected to experience. In an embodiment, the storage device mounting apparatus 800 may be used with a desktop information handling system or a server where, for example, the storage device mounting apparatus has approximately the same dimensions as a 3.5 inch storage device and the storage device 400 in storage device mounting apparatus 800 is a 2.5 inch storage device.

Referring now to FIG. 8, an alternative embodiment of a storage device mounting apparatus 900 is substantially similar in design and operation to the storage device mounting apparatus 800 described above with reference to FIGS. 1, 2a, 2b, 3a, 3b, 4, 5, 6, 7a, 7b, 7c, 7d, 7e, 7f, 7g, 7h, 7i, 7j, and 7k, with the provision of a modified storage device connector 902 having a plurality of pins 902a which replaces the storage device connector 304 having plugs 304a and 304b and which is operable to couple different types of storage devices to the information handling system 500. In an embodiment, the storage device connector 902 includes a 2.5 inch storage device PATA connector.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A storage device mounting apparatus comprising:
a modular device casing defining a storage device housing;
a shock isolation material coupled to the modular device casing and located in the storage device housing; and
a storage device positioned in the storage device housing and engaging the shock isolation material.

2. The apparatus of claim 1 wherein the modular device casing is approximately the same dimensions as a standard storage device.

3. The apparatus of claim 1 wherein the modular device casing is approximately the same dimensions as a 2.5 inch storage device.

4. The apparatus of claim 1 wherein the shock isolation material includes a plurality of shock isolation members coupled to a top portion of the modular device casing and a bottom portion of the modular device casing.

5. The apparatus of claim 1 wherein the storage device has smaller dimensions than a standard storage device.

6. The apparatus of claim 1 wherein the storage device includes a 1.8 inch storage device.

7. The apparatus of claim 1 further comprising:
a circuit board coupled to the modular device casing and electrically coupled to the storage device.

8. The apparatus of claim 7 wherein the circuit board is operable to convert from a 2.5″ parallel ATA (PATA) device signal framework to a 1.8 inch PATA device signal framework.

9. The apparatus of claim 7 wherein the circuit board is operable to convert from a 2.5″ serial ATA (SATA) device signal framework to a 1.8 inch PATA device signal framework.

10. An information handling system comprising:
a chassis defining a component slot;
a microprocessor mounted in the chassis; and
a modular device casing which is approximately the same dimensions as a standard storage device positioned in the component slot, the modular device casing comprising:
a storage device housing defined by the modular device casing;
a shock isolation material coupled to the modular device casing and located in the storage device housing; and
a storage device which has smaller dimensions than a standard storage device positioned in the storage device housing, engaging the shock isolation material, and coupled to the microprocessor.

11. The system of claim 10 wherein the modular device casing is approximately the same dimensions as a 2.5 inch storage device.

12. The system of claim 10 wherein the shock isolation material includes a plurality of shock isolation members coupled to a top portion of the modular device casing and a bottom portion of the modular device casing.

13. The system of claim 10 wherein the storage device includes a 1.8 inch storage device.

14. The system of claim 10 further comprising:
a circuit board coupled to the modular device casing and electrically coupling the storage device to the microprocessor.

15. The system of claim 14 wherein the circuit board is operable to convert from a 2.5″ PATA device signal framework to a 1.8 inch PATA device signal framework.

16. The system of claim 14 wherein the circuit board is operable to convert from a 2.5″ SATA device signal framework to a 1.8 inch PATA device signal framework.

17. The system of claim 10 wherein the component slot is operable to house a standard storage device.

18. A storage device mounting apparatus comprising:
housing means for housing an storage device, the housing means approximately the same dimensions as a standard storage device;
shock isolation means for reducing shock and vibration coupled to the modular device casing; and
a storage device which has smaller dimensions than a standard storage device positioned in the housing means and engaging the shock isolation means.

19. The apparatus of claim 18 further comprising:
means for converting signals coupled to housing means and electrically coupled to the storage device.

20. A method for mounting a storage device in an information handling system comprising:
providing a modular device casing having approximately the same dimensions as a standard storage device;
coupling shock isolation material to the modular device housing;
positioning an storage device in the modular device casing and engaging the shock isolation material, the information handling system component having smaller dimensions than a standard storage device; and
mounting the module device casing to an information handling system.

21. The method of claim 20 further comprising:
converting signals from the storage device to the information handling system.
